(19) United States
(12) Patent Application Publication
(10) Pub. No.: US 2005/0121146 A1
(43) Pub. Date: Jun. 9, 2005

(54) Label printer that dispenses labels in non-peel or automatic peel modes

(76) Inventors: Robert L. Leonard JR., Canal Fulton, OH (US); Bradley W. Borne, Uniontown, OH (US); Bryan A. Pittman, Alliance, OH (US)

Correspondence Address: Eric K. Satermo;Registered Patent Agent, P.O. Box 19099, Irvine, CA, 92623-9099, US

(21) Appl. No.: 10/979,879

(22) Filed: Nov. 1, 2004

Related U.S. Application Data
(60) Provisional application No. 60/516,097, filed on Oct. 31, 2003.

(51) Int. Cl. B32B 31/00; B32B 1/00

(52) U.S. Cl. 156/350; 156/584; 156/384

(57) ABSTRACT

A printer for use with a label assembly having a liner and a plurality of labels. The printer may include a peeling edge, a drive subassembly, and a manually actuatable peel-selector subassembly. The drive subassembly may be configured to move the label assembly through the printer and over the peeling edge. The peel-selector subassembly may be configured to enable a user to manually select between a non-peel mode and a peel mode. In a non-peel mode, the label assembly is moved over the peeling edge with the labels are attached to the liner; that is, labels are not removed from the liner while being dispensed from the printer. In a peel mode, the label assembly is moved over the peeling edge so that the labels are separated or peeled away from the liner.

### CROSS REFERENCE TO RELATED APPLICATIONS

This application claims priority under 35 U.S.C. § 119(e) on U.S. Provisional Application for Patent Ser. No. 60/516,097 filed Oct. 31, 2003. This application also relates to U.S. Design patent application Ser. No. 29/210,224 filed Jul. 27, 2004. Both of these applications are incorporated herein by reference.

### BACKGROUND OF THE INVENTION

The present invention relates to printers and, more particularly, to printers for use with a roll of labels.

Label printers are desirable for a number of applications. For example, label printers are often used in printing bar-code labels for items to be scanned and/or tracked. The label printers typically employ thermal printing devices and techniques. Examples of conventional label printers are available from Esselte Corporation under the Dymo® brand as LabelWriter printers, from Seiko Instruments USA Inc. as Smart Label Printers, and from Zebra Technologies Corporation as label and bar code printers.

During a printing operation, some conventional printers dispense a label that is removed from the printer by a user. The user then removes the label from the backing sheet or liner to apply the label to an article. When printing a large number of labels, the added step of peeling the label off of the liner repeated many times can increase the time needed for a user to complete a particular job.

Accordingly, there is a need for label printer that enables a user to select dispensing modes, either a non-peel mode in which the labels remain on the liner or a peel mode in which the labels are automatically peeled off of the liner. The present invention satisfies these needs.

### BRIEF SUMMARY OF THE INVENTION

The present invention relates to printers and, more particularly, to printers for use with a roll of labels.

According to one embodiment of the invention and by way of example only, a printer for use with a label assembly having a liner and a plurality of labels may include a peeling edge, a drive subassembly, and a manually actuatable peel-selector subassembly. The drive subassembly may be configured to move the label assembly through the printer and over the peeling edge. The peel-selector subassembly may be configured to enable a user to manually select between a non-peel mode and a peel mode. In a non-peel mode, the label assembly is moved over the peeling edge with the labels attached to the liner; that is, labels are not removed from the liner while being dispensed from the printer. In a peel mode, the label assembly is moved over the peeling edge so that the labels are separated or peeled away from the liner.

One of the advantages of the printer is that a user may utilize the printer for continuous printing of labels or for batch printing a single label or labels. For example, if continuous printing of a plurality of labels is desired, the printer may be placed in the non-peel mode so that the label assembly is dispensed from the printer continuously with the labels remaining in place on liner. And if batch printing is desired, the printer may remain in the non-peel mode with the label assembly being dispensed a single label length out of the printer; or, alternatively, the printer may be placed in the peel mode so that the label that is printed upon is automatically peeled away from the liner while being dispensed for easy removable and subsequent application by a user.

According to another embodiment, a printer may include a label-assembly holder for rotatably holding the roll of labels and a drive subassembly moving the label assembly through the printer between an input and an output. A peel selector subassembly may be manually actuated between a non-peel mode and a peel mode. In the non-peel mode, the labels remain attached to the liner when the label assembly is dispensed out of the output. In the peel mode, the labels are separated from the liner when the label assembly is dispensed out of the output.

According to still another embodiment, a printer may include a label-assembly holder for rotatably holding the roll of labels, an input for receiving the label assembly from the label holder, and a housing including a transversely disposed output slot with a peeling edge and a groove disposed at or near the output slot. The groove may have an upper extent located above the output slot and a lower extent located below the output slot. The printer may also include a drive subassembly and a peel selector subassembly. The drive subassembly receives the label assembly from input and moves the label assembly through the printer and out of the output slot. The peel selector subassembly may include a selector roller and a manual actuator. The selector roller is operably disposed in the groove to move between the upper extent and the lower extent, and the manual actuator is operably connected to the selector roller and projects beyond the housing for manual manipulation by a user to select between a non-peel mode and a peel mode. In the non-peel mode, the selector roller is positioned at the upper extent of the groove such that the label remains attached to the liner when the label assembly is dispensed out of the output slot. In the peel mode, the selector roller is positioned at the lower extent of the groove such that the label assembly contacts the peeling edge to cause the label to peel away from the liner when the label assembly is dispensed out of the output slot.

Other features and advantages of the present invention will become apparent to those skilled in the art from a consideration of the following detailed description taken in conjunction with the accompanying drawings.

### BRIEF DESCRIPTION OF THE SEVERAL VIEWS OF THE DRAWINGS

FIGS. 1A and 1B are perspective views of an embodiment of a printer operating in a non-peel mode and a peel mode, respectively;

FIG. 2 is a perspective view of a printer with a cover pivoted open;

FIG. 3 is a perspective view of a roll of labels;

FIG. 4 is a cross-sectional view taken along line 4-4 of FIG. 3;

FIGS. 5A and 5B schematically illustrate an embodiment of a printer operating in a non-peel mode and a peel mode, respectively;

FIGS. 6A and 6B are perspective views illustrating an embodiment of a printer operating in a non-peel mode and a peel mode, respectively;

FIG. 7A is a cross-sectional view illustrating a label assembly passing through an output of a printer in a non-peel mode;

FIGS. 7B1 and 7B2 are cross-sectional views illustrating a label assembly passing over a peeling edge of an output of a printer in a peel mode;

FIG. 8 is a block diagram of an electrical system of a printer;

FIGS. 9A and 9B schematically and respectively illustrate a print head engaged with and disengaged from a drive roller of a printer;

FIG. 10 is a perspective view of an input of a printer, particularly illustrating a label assembly being positioned at the input;

FIG. 11 schematically illustrates a peel selector subassembly of a printer;

FIG. 12 is a block diagram of a printer connected to a computer;

FIGS. 13 and 14 are fragmentary plan views of label assemblies of different sizes;

FIG. 15 is a perspective view of a roll of labels mounted in a spool; and

FIG. 16 illustrates a mounting of a spool with a roll of labels into a cover of a printer.

### DETAILED DESCRIPTION OF THE INVENTION

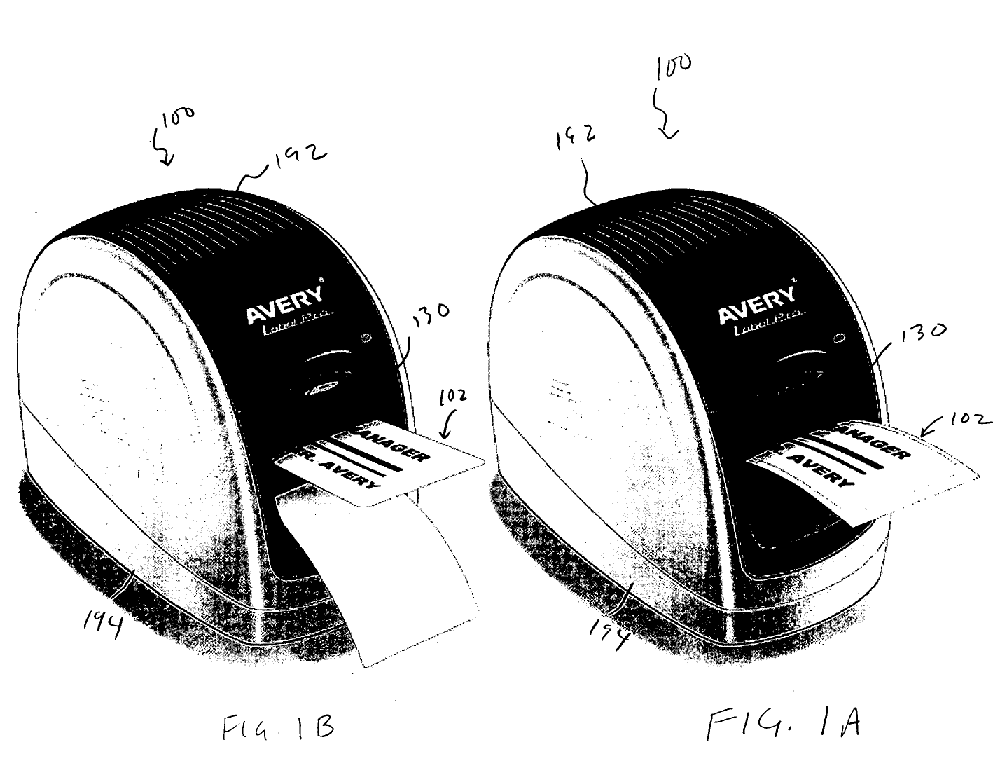

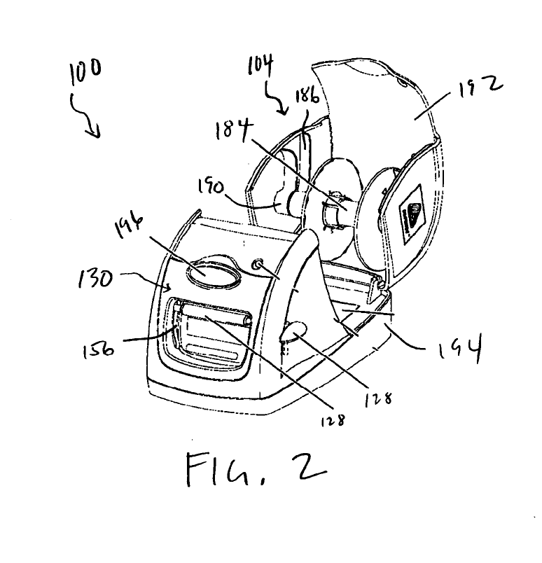

Referring to the drawings, a printer 100 for use with a label assembly 102 is shown in FIGS. 1A and 1B according to a number of embodiments. As described in detail herein, the printer 100 may be configured to operate in two modes, namely, a non-peel mode as shown in FIG. 1A in which the label assembly 102 remains intact when dispensed from the printer, and a peel mode as shown in FIG. 1B in which labels are separated from the liner of the label assembly 102.

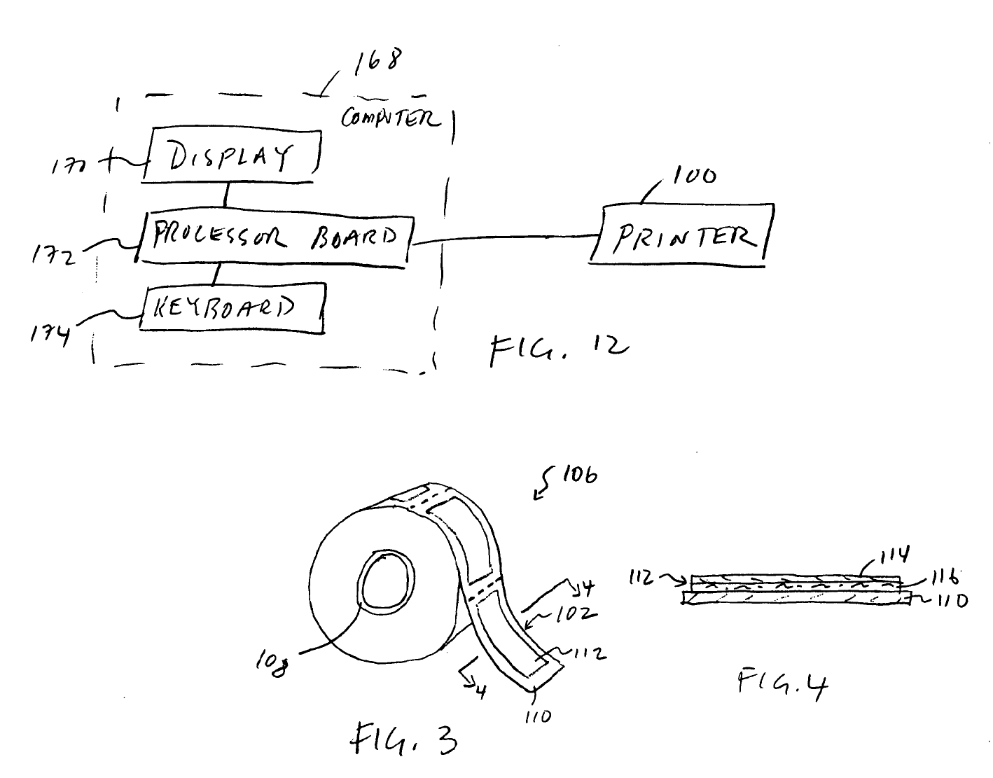

According to a number of embodiments as illustrated in FIG. 2, the printer 100 may include a label-assembly holder 104 for rotatably holding a roll of labels 106, an example of which is shown in FIG. 3. The roll of labels 106 may include the label assembly 102 wound about a core 108. The label assembly 102 may in turn include a liner 110 with a release coating and a plurality of labels 112 releasably attached to the liner 110. Each of the labels 112 may include facestock 114 and a layer of adhesive 116 as shown in FIG. 4. For many applications, the labels 112 may be disposed on the liner 110 in a single-file manner, as shown in FIG. 3.

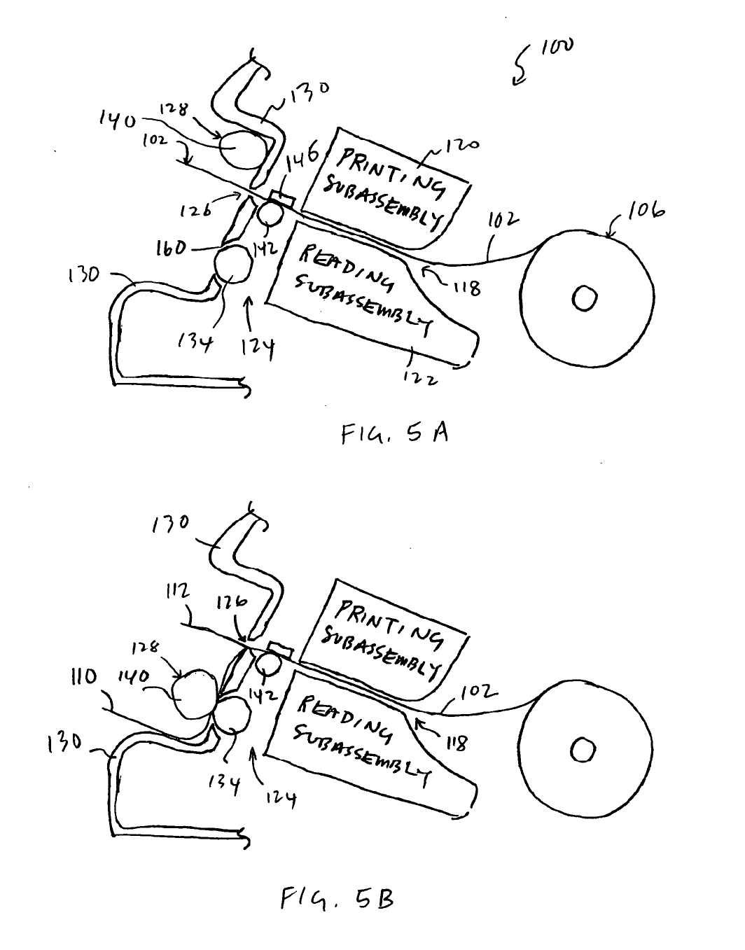

With additional reference to FIG. 5A, the printer 100 may include an input 118 for receiving the label assembly 102 from the label holder 104 or the roll of labels 106 and through which the label assembly 102 enters an operative portion of the printer 100, including, for example, a print subassembly 120, a read subassembly 122, and a drive subassembly 124, each of which will be described in more detail below. The printer 100 may also include an output 126 through which the label assembly 102 is dispensed from the printer 100. The drive subassembly 124 is configured to propel, drive, or move the label assembly 102 from the input 118 to the output 126.

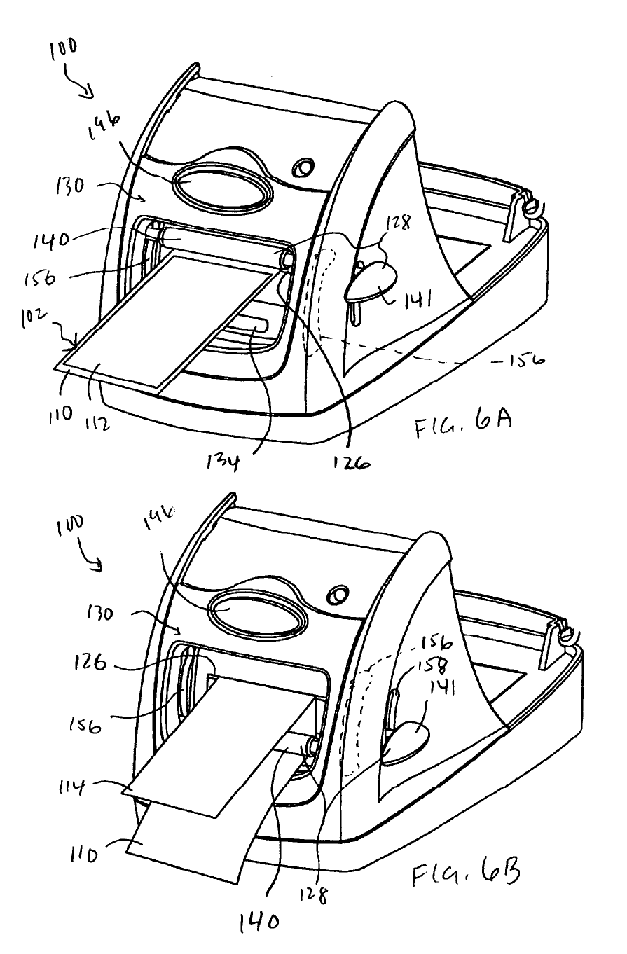

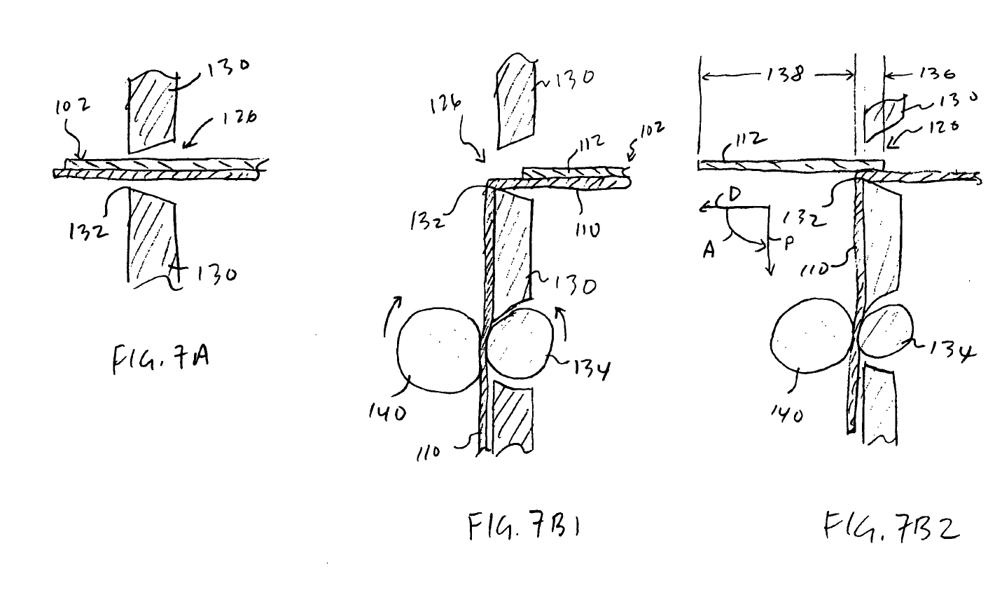

According to a number of embodiments, the printer 100 may also include a peel selector subassembly 128 which is shown in more detail in FIGS. 6A and 6B. The peel selector subassembly 128 may be manually actuated or moved by a user to switch the printer 100 between the non-peel mode shown in FIGS. 1A, 5A, and 6A in which the labels 112 remain affixed, attached, or adhered to the liner 110 when dispensed through the output 126 and the peel mode shown in FIGS. 1B, 5B, and 6B in which the labels 112 are detached, separated, or peeled away from the liner 110.

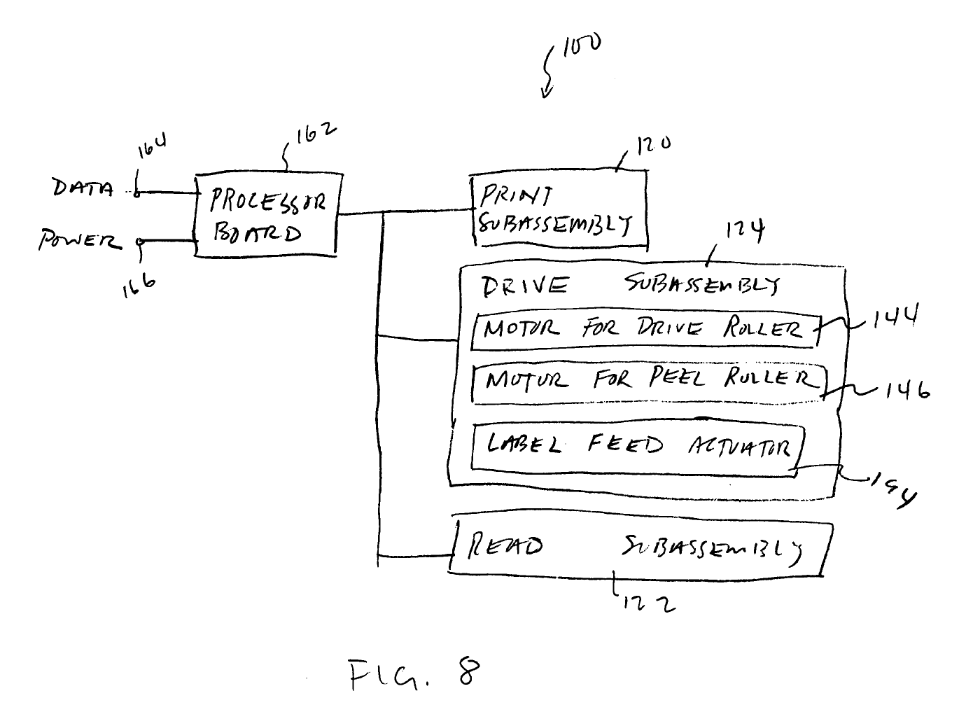

With continued reference to FIGS. 5 and 6, the printer 100 may include a housing or bezel 130 through which the output 126 may be formed, for example, as a transversely disposed slot. In a number of embodiments such as illustrated in FIG. 7A, a peeling edge 132 may be defined on the housing or bezel 130 at the output slot 126, such that the label assembly 102 passes over the peeling edge 132 when dispensed out of the output slot 126.

As shown in FIGS. 5A, 5B, and 6A, and with additional reference to FIGS. 7B1 and 7B2, in a number of embodiments the drive subassembly 124 may include a peel roller 134 that is configured to engage the liner 110 when the printer 100 is in the peel mode. The peel roller 134 may be positioned with respect to the peeling edge 132 so that when the printer 100 is in the peel mode, the liner 110 is bent about the peeling edge 132 at an angle that is sufficient to cause the labels 112 to peel away from the liner 110 as shown in FIGS. 5B, 6B, and 7B2.

For example, as shown in FIG. 7B2, when the printer 100 is in the peel mode, the label 112 may be dispensed out of the output 126 along a label path indicated by arrow D, and the liner 100 may be driven along a liner path indicated by arrow P. The peel roller 134 may be positioned with respect to the peeling edge 132 so that the liner path P is divergent from the label path D at the peeling edge 132 at an angle A of at least about 45 degrees and, in many embodiments, of about 90 degrees as shown.

With further reference to FIGS. 4 and 7B2, the magnitude of angle A depends on the level of adhesive between the adhesive layer 116 and the release coating of the liner 110 and on the amount of stiffness of the facestock 114 of the label 112. For example, if the facestock 114 is relatively stiff and the adhesion between the adhesive layer 116 and the liner 110 is relatively low, then the divergent angle A may relatively small (e.g., about 45 degrees). Alternatively, if the facestock 114 is relatively flimsy and the adhesion of the label 112 to the liner 110 is relatively high, then the divergent angle A may be relatively high (e.g., about 90 degrees). Accordingly, to maximize applicability to all label assemblies, in many of the embodiments the divergent angle A may be about 90 degrees.

Referencing FIG. 7B2, in a peel-mode printing operation, the drive subassembly 124 may move the label assembly 102 out of the output 126 to a dispense point at which an adhered portion 136 of the label 112 is still attached to the liner 110 and then may maintain the label assembly 112 at that dispense point. A user may then grasp a peeled or extended portion 138 of the label 112 and remove the label 112 from the liner 110 by pulling. Depending on the stiffness of the facestock 114 and the adhesion of the adhesive layer 116 with the liner 110, the adhered portion 136 may be less than about 50% of the total length of the label 112, for example, less than about 10% of the of the total length of the label 112.

Accordingly, the printer 100 may easily be utilized by a user for continuous printing of labels 112, for printing a single label or labels 112, or for batching printing a plurality of labels 112 each with the same printed information. For example, if continuous printing of a plurality of labels 112 is desired, the printer 100 may be placed in the non-peel mode so that the label assembly 102 is dispensed from the printer 102 continuously with the labels 112 remaining in place on liner 110. If batch printing is desired, the printer 100 may remain in either the non-peel mode or the peel mode. If batch printing in the peel mode, the label assembly may be dispensed a single label length out of the printer 100, with the user then removing the dispensed label 112 from the label assembly 102. Alternatively, if batch printing in the peel mode, the label 112 that is printed upon is automatically peeled away from the liner 110 while being dispensed for easy removable and subsequent application by a user to a desired surface or object.

With reference to FIGS. 5, 6, and 7B, in a number of embodiments the peel selector subassembly 128 may include a selector roller 140 and a manual actuator 141. By moving the manual actuator 141, the selector roller 140 is selectively movable between a non-peel position shown in FIGS. 5A and 6A in which the selector roller 140 is disengaged from the peel roller 134, thereby rendering the printer 100 in the non-peel mode, and a peel position as shown in FIGS. 5B, 6B, and 7B in which the selector roller 140 is engaged with the peel roller 134, thereby rendering the printer 100 in the peel mode.

As particularly shown in FIG. 7B, when in the peel position, the selector roller 140 presses the liner 110 against the peel roller 134. Accordingly, when the drive roller 134 rotates, the selector roller 140 rotates in the opposition direction as shown by the arrows in FIG. 7B1 with the liner 110 being propelled therebetween. By propelling the liner 110 at a divergent angle A of about 90 degrees, the rollers 134 and 140 pull the liner 110 tightly against the peeling edge 132 to enhance the peeling of the label 112 away from the liner 110.

Referencing the embodiments of FIG. 5, in addition to the peeler roller 134, the drive subassembly 124 may further include a drive roller 142 for moving or propelling the label assembly 102 through the printer 100 and out of the output 126. As shown in FIG. 8, in some of the embodiments the drive subassembly 124 may include a motor 144 for the drive roller 142 and a motor 146 for the peel roller 134. In other the embodiments, a single motor may drive both of the rollers 134 and 142.

To enhance efficient operation during the peel mode, the drive roller 142 may drive the label assembly 102 at substantially the same speed that the peel roller 134 drives the liner 110. Accordingly, slack in the label assembly 102 downstream of the drive roller 142 is minimized or prevented. In embodiments in which the rollers 134 and 142 have the same circumference, the rollers 134 and 142 may rotate at the same speed in the peel mode.

In a number of embodiments, the print subassembly 120 may be configured as a thermal printer. Accordingly, as shown in FIG. 5, the print subassembly 120 may include a thermal print head 146 that is biased or urged against the drive roller 142 so such that the labels 112 are pressed against the print head 146 when the drive roller 142 moves the label assembly 102 to the output 126.

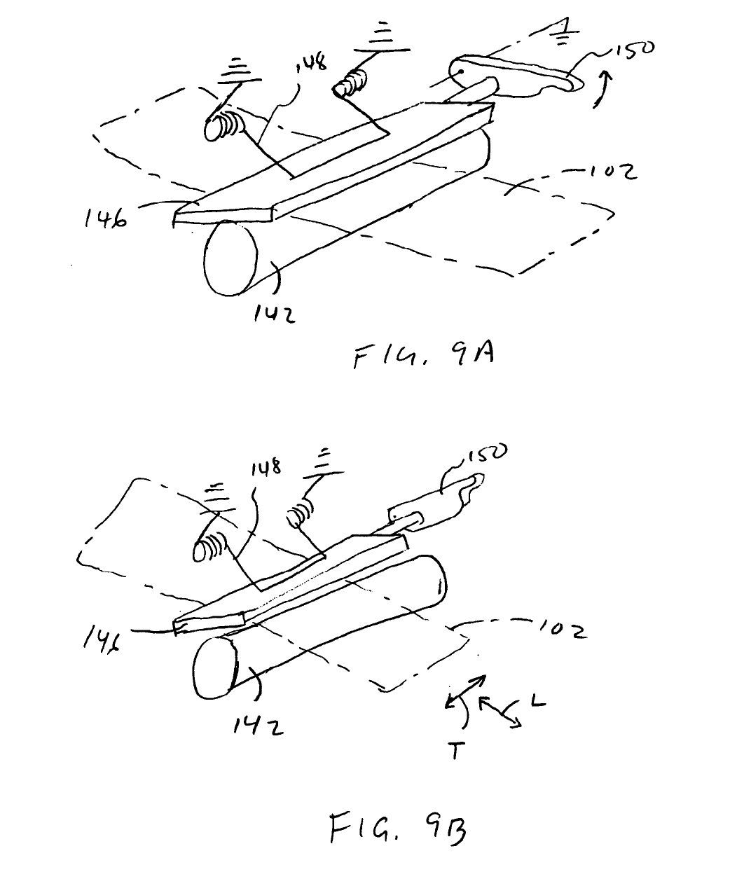

For example, as shown in FIGS. 9A and 9B, the printer 100 may include a spring 148 that is configured to bias or urge the print head 146 against the drive roller 142, as particularly shown in FIG. 9A. In a number of embodiments, the printer 100 may include manually actuatable release arm 150 that is operably connected to the print head 146. The release arm 150 enables a user to move the print head 146 away from or to disengaged the print head 146 from the drive roller 142, thereby allowing the label assembly 102 to move freely therebetween as shown by arrows T and L in FIG. 9B. (The use of the electrical grounding symbols in FIGS. 9A and 9B indicates that the referenced element at that particular point is fixed; e.g., the release arm 150 is pivotal about a fixed point, and the spring 148 is fixed at the ends thereof.)

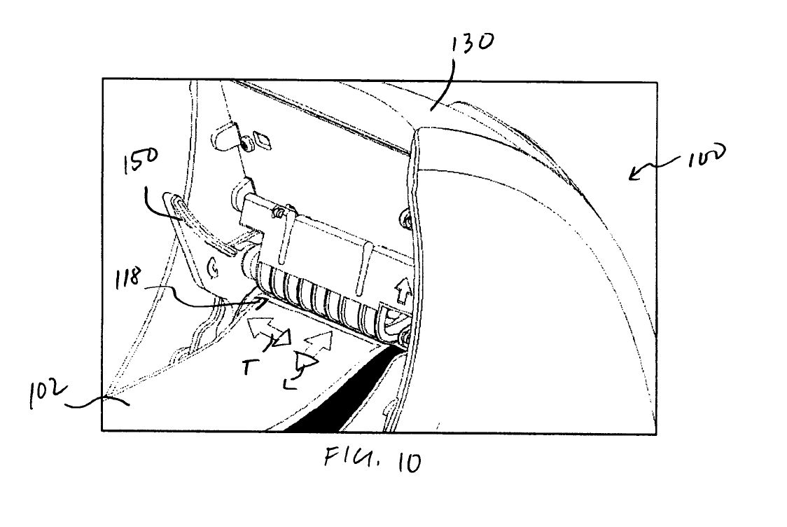

With reference to FIG. 10, the ability to move the print head 146 enables a user to manually position a label assembly 102 at the input 118 in both the transverse direction T and longitudinal direction L. As shown, the release arm 150 may be conveniently positioned at or near the input 118. When in a desired position, the release arm 150 may be released to engage the label assembly 102 between the drive roller 142 and the print head 146.

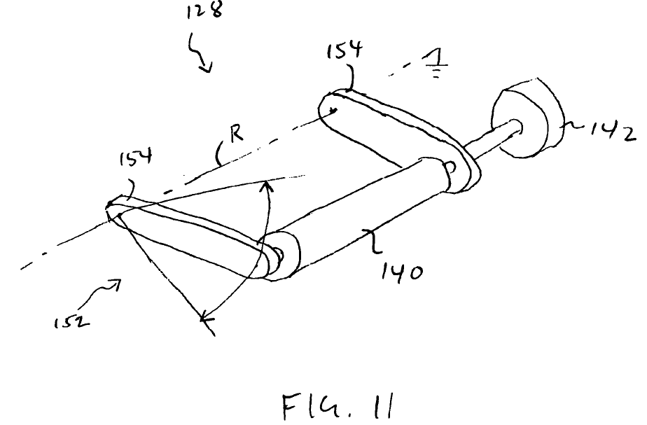

With additional reference to FIG. 11, in a number of embodiments the peel selector subassembly 128 may include a pivotal harness 152 connected to the manual actuator 141. The selector roller 140 may then be rotatably mounted in the harness 152, for example, between a pair of arms 154. The harness 152 may be pivotal about an axis R so that the selector roller 140 may be moved between the non-peel and peel positions.

To facilitate the movement of the harness 152 and the selector roller 140, the housing or bezel 130 may include a pair of opposing grooves 156 disposed at or near the output slot 126 in which ends of the selector roller 140 are operably slidable or translatable between the non-peel position and the peel position, as shown in FIG. 6. For example, in some of the embodiments, the grooves 156 may have an upper extent located above the output slot 126 and a lower extent located below the output slot 126. Accordingly, the selector roller 140 is in the non-peel position when positioned at the upper extent of the grooves 156 and in the peel position when positioned at the lower extent of the grooves 156.

The bezel 130 may also include a track 158 through which the actuator 141 may connect to the harness 152 (not shown in FIG. 6). In addition, as shown in FIGS. 5A and 6A, the bezel 130 may also include a roller opening 160 through which the peeler roller 134 is engageable by the selector roller 140 when in the peel position.

Referencing FIG. 8, in a number of embodiments the printer 100 may include a processor board 162 operably connected to the print subassembly 120, the drive subassembly 124, and the read subassembly 122. The processor board 162 may include a data input 164 and a power supply input 166 for connecting to a power supply. The data input 164 may include a USB port, a wireless communication module, or other data-transfer device. As shown in FIG. 12, the printer 100 may be connected to a data source such as a printer 168 via the data input 164. The computer 168 may include a display 170, a processor board 172 with memory, and a keyboard 174. The computer 168 may include a software application that drives printing operations for the printer 100. In other embodiments, the printer 100 may include dedicated printing applications for stand-along use.

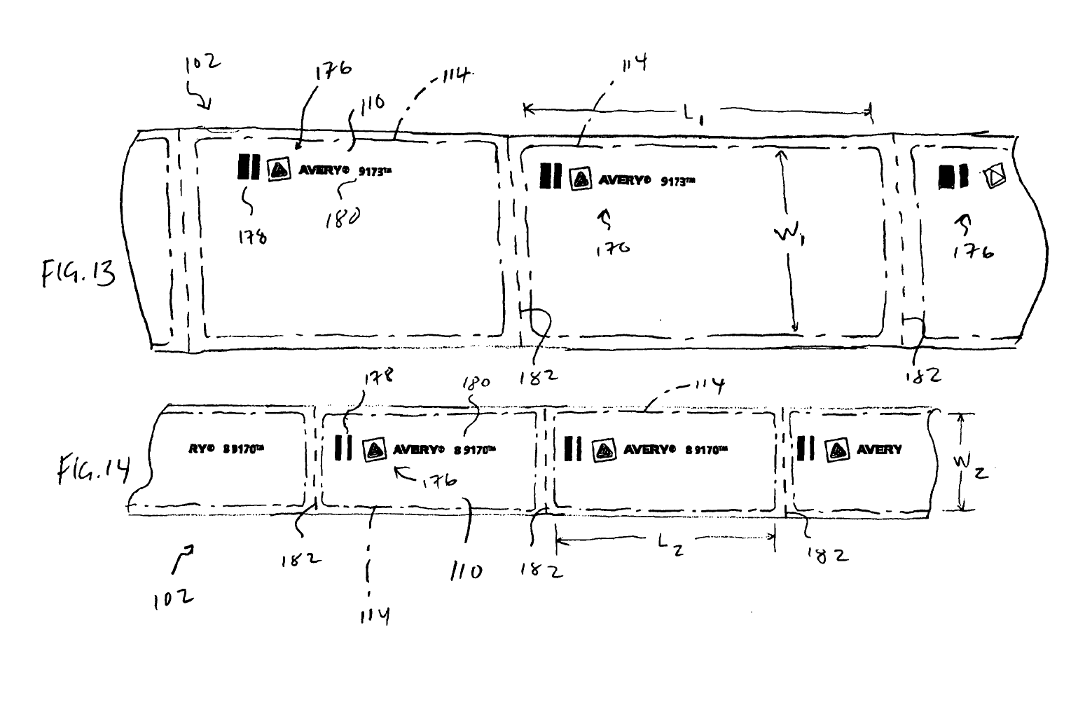

As shown in FIGS. 5 and 8, the printer 100 may include in some of the embodiments the read subassembly 122. As mentioned above, the read subassembly 122 may be configured to read machine-readable information on the label assembly 102. For example, with reference to FIGS. 13 and 14, the label assembly 102 may include machine-readable information 176 printed on a back of the liner 110 (with the labels 112 being adhered to a front of the liner 110). The machine-readable information 176 may include a bar code 178. Other manufacturer's information 180 may also be printed on the liner 110. When read, the bar code 176 may provide information relevant to the label assembly 102, such as a length L and a width W of the labels 112. In addition, the read subassembly 122 may sense the bar code 176 to selectively stop the feeding of the label assembly 102 if a previously printed and peeled label has not been removed by the user.

In this regard, in a number of embodiments, the printer 100 may be configured to print on labels 112 of varying size. For example, as shown in FIG. 13, the read subassembly 122 may read the bar code 178 to indicate that the labels 112 of the roll of labels 106 loaded in the printer 100 has a length L₁ and a width W₁. Further, if a user replaces a particular roll of labels 106 with another as shown in FIG. 14, the read subassembly 122 may read the bar code 178 to indicate that the labels 112 of the replacement roll of labels 106 has a length L₂ and a width W₂, which may be different from the dimensions of the other roll. The processor board 162 of the printer 100 may then use this size information in formatting the printing parameters on a computer. In addition to recognizing a length and a width of the labels 112, the bar code 178 may also provide the location or spacing of the leading and trailing edges of each of the labels 112. Examples of widths and lengths of label including ½ inch by 1 3/4 inches, 1 inch by 2⅝ inches, and 2⅛ inches by 3½ inches.

In a number of embodiments, the read subassembly 122 may include a light source (not shown) for reading the machine-readable information 176. An example of one of the embodiments of the read subassembly 122 is disclosed in U.S. Patent Application Publication No. 2004/0050854, which is a continuation-in-part application of U.S. Patent Application Publication No. 2004/0050497. These applications disclose methods and apparatus for reading machine-readable coded information such as bar codes printed on a liner sheet of a label assembly. The disclosures of these two applications are incorporated herein by reference.

As shown in FIGS. 13 and 14, the machine-readable information 176 may be repeated along the length of the label assembly 102. In addition, the label assembly 102 may include weakening lines 182 such as perforations spaced between individual facestocks 114 so that when dispensed in the non-peel mode, such as shown in FIG. 1A, individually printed labels 112 may be removed from the label assembly 102 along the weakening lines 182.

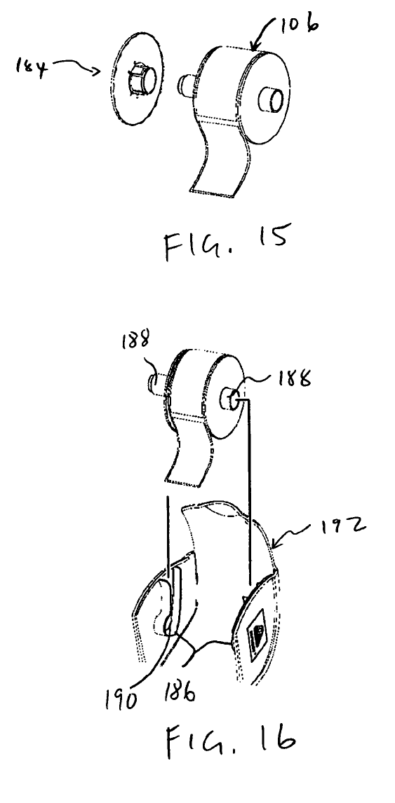

Referring to the label-assembly holder 104 in more detail, reference is made to FIGS. 2, 15 and 16. The printer 100 may include a removable spool 184 on which a roll of labels 106 may be mounted as shown in FIG. 15. The printer 100 may also include a pair of opposing grooves or tracks 186 in which an axle 188 of the spool 184 are slidingly receivable. Each of the tracks 186 may include a seat 190 in which the axle 188 is rotatably received. The tracks 186 may be formed on an inside of a cover 192 that is pivotally mounted to a base 194 of the printer 100 as shown in FIGS. 1 and 2. Accordingly, a user may interchange and mount a roll of labels 106 easily in the label-holder assembly 104 when the cover 194 is open, and the label assembly 102 is operably receivable at the input 118 when the cover 194 is closed. In addition, the axle 188 of the spool 184 may have a transverse width that is sufficient to accommodate labels 112 of varying width. As shown in FIG. 6, the bezel 130 may also be mounted to the base 194.

With reference to FIGS. 5, 6, and 11, in a number of embodiments the selector roller 140 may be positioned above the output 126 when in the non-peel position as shown in FIGS. 5A and 6A, and may be positioned below the output 126 when in the peel position as shown in FIGS. 5B and 6B. Accordingly, when switching the printer from non-peel mode to peel mode, a portion of the label assembly 102 may be extended beyond the output 126, and the selector roller 128 may be moved downward, contacting a top surface of the label assembly 102 and drawing the label assembly 102 downward until the label assembly 102 is sandwiched between the selector roller 128 and the peeler roller 134. When dispensed, the liner 110 contacts the peeling edge 132, causing the labels 112 to peel away from the liner 110.

In this regard, to facilitate the advancement of the label assembly 102 out of the output 126, the drive subassembly 124 may include a label feed actuator 194 as shown in FIG. 8 with a manual actuation button 196 as shown in FIGS. 2 and 6. Upon actuation of the button 196, the feed actuator 194 may advance the label assembly 102 out of the output 126 a desired distance or length. This step may be performed prior to switching the position of the selector roller 140 from the non-peel position to the peel position. The manual advancement of the label assembly 102 may also be useful in initially advancing the label assembly 102 through the printer 100 upon mounting a new roll of labels 106 in the printer. In addition, during batch printing a plurality of labels 112 in the peel mode, after a user has removed a peel label 112 from the assembly 102, the actuation button 196 may be pressed to cause the printer 100 to dispense the next label 112 which, in turn, may be removed, with the process repeated for the entire batch.

As mentioned above, the printer 100 may operate according to a software application executed by either a computer 168 or by the processor board 162 of the printer 100 itself. An example of the operation of the printer 100 and software application may be found in “Personal Label Printer: Quick Start Guide” which is available as Part No. 1271002800, available from Avery Dennison Cooperation, Office Products North America, Brea, Calif. 92821. An example of the printer 100 is marketed as Personal Label Printer, Model No. 9100, available from Avery Dennison Cooperation, Office Products North America, Brea, Calif. 92821.

Those skilled in the art will understand that the preceding embodiments of the present invention provide the foundation for numerous alternatives and modifications thereto. These other modifications are also within the scope of the present invention. Accordingly, the present invention is not limited to that precisely as shown and described in the present invention.

1. A printer for use with a roll of labels having a label assembly wound about a core, the label assembly including a liner and a plurality of labels releasably attached to the liner in a single-file manner, the printer comprising:
a label-assembly holder for rotatably holding the roll of labels;
an input for receiving the label assembly from the label holder;
a housing including a transversely disposed output slot with a peeling edge and a groove disposed at or near the output slot and having an upper extent located above the output slot and a lower extent located below the output slot;
a drive subassembly for receiving the label assembly from input and for moving the label assembly through the printer and out of the output slot; and
a peel selector subassembly including:
a selector roller operably disposed in the groove to move between the upper extent and the lower extent; and
a manual actuator operably connected to the selector roller and projecting beyond the housing for manual manipulation by a user to select:
a non-peel mode in which the selector roller is positioned at the upper extent of the groove such that the label remains attached to the liner when the label assembly is dispensed out of the output slot; and
a peel mode in which the selector roller is positioned at the lower extent of the groove such that the label assembly contacts the peeling edge to cause the label to peel away from the liner when the label assembly is dispensed out of the output slot.

2. The printer of claim 1 wherein the housing includes a pair of the grooves opposingly disposed at or near the slot;
the selector roller being slidingly disposed in the grooves to move between the upper extent and the lower extent of the grooves.

3. The printer of claim 1 further comprising a pivotal cover in which the label-assembly holder is operably disposed such that the roll of labels is mountable in the cover when the cover is open and the label assembly is operably receivable at the input when the cover is closed.

4. A printer for use with a roll of labels having a label assembly wound about a core, the label assembly including a liner and a plurality of labels releasably attached to the liner in a single-file manner, the printer comprising:
a label-assembly holder for rotatably holding the roll of labels;
an input for receiving the label assembly from the label holder;
a drive subassembly for receiving the label assembly from input and for moving the label assembly through the printer;
an output through which the label assembly is dispensed from the printer; and
a peel selector subassembly for selecting upon manual actuation between:
a non-peel mode in which the label remains attached to the liner when the label assembly is dispensed out of the output; and
a peel mode in which the label is separated from the liner when the label assembly is dispensed out of the output.

5. The printer of claim 4 wherein:
the output includes a peeling edge over which the label assembly passes when dispensed out of the output; and
the drive subassembly includes a peel roller for engaging the liner when in the peel mode;
the peel roller being positioned with respect to the peeling edge such that when in the peel mode, the liner is bent about the peeling edge at an angle that peels the labels away from the liner.

6. The printer of claim 5 wherein when in the peel mode, the label is dispensed out of the output along a label path, and the liner is driven along a liner path that is divergent from the label path at the peeling edge at an angle of at least about 45 degrees.

7. The printer of claim 6 wherein the liner path is divergent from the label path at the peeling edge at an angle of about 90 degrees.

8. The printer of claim 6 wherein the drive subassembly moves the label assembly out of the output when printing in the peel mode to a dispense point at which a portion of the label is still attached to the liner and maintains the label assembly at the dispense point.

9. The printer of claim 5 wherein the peel selector subassembly includes a selector roller and a manual actuator for selectively moving the selector roller between a non-peel position in which the selector roller is disengaged from the peel roller and a peel position in which the selector roller is engaged with the peel roller.

10. The printer of claim 9 wherein the selector roller presses the liner against the peel roller in the peel position.

11. The printer of claim 9 wherein the drive subassembly further includes a drive roller for propelling the label assembly out of the output.

12. The printer of claim 11 wherein the drive roller drives the label assembly at substantially the same speed that the peel roller drives the liner when in the peel mode.

13. The printer of claim 9 further comprising a print subassembly operably connected to the drive subassembly and including a thermal print head that is spring biased against the drive roller such that the labels are pressed against the print head when the drive roller moves the label assembly to the output.

14. The printer of claim 13 further comprising a manually actuatable release arm operably connected to the print head for selectively moving the print head away from the drive roller to allow the label assembly to move freely therebetween.

15. The printer of claim 9 wherein the peel selector subassembly includes a pivotal harness connected to the manual actuator and in which the selector roller is rotatably mounted.

16. The printer of claim 15 further comprising a bezel through which the output is formed and including a pair of opposing grooves in which ends of the selector roller are translatable between the non-peel position and the peel position.

17. The printer of claim 16 wherein the bezel includes a roller opening through which the peeler roller is engageable by the selector roller when in the peel position.

18. The printer of claim 4 further comprising a processor board operably connected with the drive subassembly and including a data input for connecting with a data source and a power supply input for connecting to a power supply.

19. The printer of claim 18 further comprising a print subassembly operably connected with the processor board and the drive subassembly for printing on the labels.

20. The printer of claim 18 further comprising a read subassembly operably connected to the processor board for reading machine-readable information, if any, on the label assembly.

21. A printer for use with a label assembly including a liner and a plurality of labels, the printer comprising:
a peeling edge;
a drive subassembly for moving the label assembly through the printer and over the peeling edge; and
a peel-selector subassembly operably connected to the drive subassembly for enabling selection between:
a non-peel mode in which the label assembly is moved over the peeling edge so that the labels are attached to the liner; and
a peel mode in which the label assembly is moved over the peeling edge so that the labels are separated from the liner.

22. The printer of claim 21 wherein the peel-selector subassembly is manually actuatable between the non-peel and peel modes.

23. The printer of claim 21 wherein the drive subassembly includes a peel roller for engaging the liner when in the peel mode;
the peel roller being positioned with respect to the peeling edge such that when in the peel mode, the liner is bent about the peeling edge at an angle that is sufficient to cause the labels to peel away from the liner.

24. The printer of claim 23 wherein peel roller is positioned with respect to the peeling edge such that the liner is bent through an angle of about 90 degrees when engaged by the peel roller in the peel mode.

25. The printer of claim 23 wherein the drive subassembly is configured to move the label assembly over the peeling edge in the peel mode to a dispense point at which a portion of the label is still attached to the liner and then maintain the label assembly at the dispense point.

26. The printer of claim 23 wherein the peel selector subassembly includes a selector roller and a manual actuator for selectively moving the selector roller between a non-peel position in which the selector roller is disengaged from the peel roller and a peel position in which the selector roller is engaged with the peel roller.

27. The printer of claim 26 wherein the liner is engaged by and propelled between the peel roller and the selector roller when the peel roller is in the peel position.

28. The printer of claim 26 wherein the drive subassembly further includes a drive roller for moving the label assembly upstream of the peeling edge;
the peel roller being positioned downstream of the peeling edge.

29. The printer of claim 28 wherein the drive roller drives the label assembly at substantially the same speed that the peel roller drives the liner when in the peel mode.

30. The printer of claim 21 further comprising a print subassembly operably connected to the drive subassembly and including a thermal print head that is spring biased against the drive roller such that the labels are pressed against the print head when the drive roller moves the label assembly to the peeling edge.
